(19) United States
(12) Patent Application Publication
(10) Pub. No.: US 2023/0160699 A1
(43) Pub. Date: May 25, 2023

(54) METHOD AND APPARATUS FOR VEHICLE LOCALIZATION AND ENHANCED VEHICLE OPERATION

(71) Applicant: HERE GLOBAL B.V., Eindhoven (NL)

(72) Inventor: Jingwei XU, Buffalo Grove, IL (US)

(73) Assignee: HERE GLOBAL B.V., Eindhoven (NL)

(21) Appl. No.: 17/532,753

(22) Filed: Nov. 22, 2021

(51) Int. Cl. G01C 21/30; G01C 21/00; G06K 7/14

(52) U.S. Cl. CPC G01C 21/30; G01C 21/3815; G01C 21/3841; G06K 7/1413

(57) ABSTRACT

A method, apparatus and computer program product are provided to estimate the location of a vehicle based at least in part upon one or more data objects obtained by one or more sensors onboard the vehicle. One or more road segment attributes may be determined for one or more road segment indicia identified by the one or more data objects and the location of the vehicle may be estimated based at least in part upon the one or more road segment attributes. Furthermore, one or more driving profiles associated with the estimated location of the vehicle may be accessed and one or more navigational instructions may be determined based at least in part on one or more driving profile attributes of the one or more driving profiles. As a result, the vehicle may be navigated in a more informed and reliable manner.

### TECHNOLOGICAL FIELD

An example embodiment relates generally to a method, apparatus and computer program product for estimating the location of a vehicle and, more particularly, to a method, apparatus and computer program product for estimating the location of a vehicle at least partly based upon one or more road segment attributes for a road segment upon which a vehicle is traveling.

### BACKGROUND

In order to provide for navigation of vehicles, the location of a vehicle must be known or estimated with sufficient accuracy. In this regard, the location of the vehicle includes the road segment upon which the vehicle is traveling and, in some instances, the lane of the road segment in which the vehicle is traveling. For example, the navigation of autonomous vehicles generally relies upon knowledge of the location of the vehicle including the road segment and the lane of the road segment in which the vehicle is traveling. Based upon the location of the vehicle, a vehicle, such as an autonomous vehicle, may be navigated along a road network from an origin to a destination, such as based upon the current location of the vehicle and traffic information for the road segment along which the vehicle is traveling, such as provided by one or more traffic service providers.

Vehicles, such as autonomous vehicles, are capable of identifying their location in line-of-sight situations utilizing satellite-based navigation and then map matching their location to a road segment defined by a map. For example, an autonomous vehicle may include a global navigation satellite system (GNSS) receiver that interacts with a global positioning system (GPS), a global navigation satellite system (GLONASS), a Galileo navigation satellite system or a BeiDou navigation satellite system. The GNSS receiver receives signals from a plurality of satellites, such as four or more satellites, and determines the location of the vehicle utilizing, for example, a triangulation method. In instances in which the GNSS receiver of an autonomous vehicle maintains a line-of-sight with the satellites, the location that the vehicle may be determined with sufficient accuracy so as to satisfy many applications. As additional navigation satellite systems are placed in commercial service in the future, a combination of navigation satellite systems may be utilized in order to provide more accurate location estimation for an autonomous vehicle so long as the GNSS receiver maintains a line-of-sight with the respective satellites.

### BRIEF SUMMARY

A method, apparatus and computer program product are provided in accordance with an example embodiment in order to estimate the location of a vehicle. In this regard, the location of a vehicle is estimated based at least in part upon one or more road segment indicia that are described by one or more data objects obtained by one or more sensors onboard the vehicle. By relying at least in part upon the one or more road segment indicia, the location of the vehicle may be estimated with enhanced accuracy in at least some situations, such as in instances in which a GNSS receiver is unable to maintain a line-of-sight with the satellites of a satellite positioning system or otherwise in instances in which the location estimated based upon reliance on satellite or radio signals is considered insufficient. By estimating the location of the vehicle with enhanced accuracy in at least some situations, the vehicle may be navigated in a more informed and reliable manner and the relationship of the vehicle to other vehicles traveling along the same or proximate road segments may be determined with greater confidence. Furthermore, in some embodiments, one or more driving profiles associated with the estimated location of the vehicle may be accessed from a driving profile database and one or more navigational instructions may be generated based at least in part on the one or more driving profiles. As such, the vehicle may be operated in a more reliable manner as compared to conventional methods.

In an example embodiment, the method includes identifying one or more road segment indicia based at least in part upon one or more data objects obtained by one or more sensors onboard the vehicles. The method may further include determining one or more road segment attributes for the road segment upon which the vehicle is traveling based at least in part on the one or more identified road segment indicia and using a road segment indicia map database. The method may further include estimating the location of the vehicle based at least in part upon the one or more road segment attributes.

In some embodiments, the method further includes accessing one or more driving profiles associated with the estimated location of the vehicle. The method may further include determining one or more navigational instructions based at least in part on the one or more driving profile attributes for one or more driving profiles.

In some embodiments, the one or more road segment indicia include one or more barcodes and each barcode is assigned a unique barcode identifier. The method may further include determining the unique barcode identifier for each road segment indicia. The method may further include matching the unique barcode identifier to a corresponding stored barcode identifier within the road segment indicia map database.

In some embodiments, the method further includes generating a driving profile associated with a vehicle route, wherein (i) the driving profile comprises one or more driving profile attributes, (ii) each of the one or more driving profile attributes is associated with one or more road segment indicia, and (iii) the one or more driving profile attributes includes at least one of a speed profile, deceleration profile, acceleration profile, steering profile, or safety events. The method may further include causing the driving profile to be provided to a road segment indicia server.

In some embodiments, the method further includes identifying a distance between the vehicle and the one or more road segment indicia, wherein estimating the location of the vehicle comprises refining the location of the vehicle within the lane of the road segment based at least in part on the respective distances between the vehicle and the one or more road segment indicia.

In some embodiments, the method further includes detecting a road segment indicum is missing based at least in part upon the one or more data objects and the road segment indicia map database defining respective locations of a plurality of road segment indicia.

In some embodiments, the one or more road segment attributes include location information for the one or more road segment indicia. In some embodiments, the one or more sensors onboard the vehicle include one or more infrared sensors.

In an example embodiment, an apparatus includes means for identifying one or more road segment indicia based at least in part upon one or more data objects obtained by one or more sensors onboard the vehicles. The apparatus may further include means for determining one or more road segment attributes for the road segment upon which the vehicle is traveling based at least in part on the one or more identified road segment indicia and using a road segment indicia map database. The apparatus may further include means for estimating the location of the vehicle based at least in part upon the one or more road segment attributes.

In some embodiments, the apparatus may further include means for accessing one or more driving profiles associated with the estimated location of the vehicle. The apparatus may further include means for determining one or more navigational instructions based at least in part on the one or more driving profile attributes for one or more driving profiles.

In some embodiments, the one or more road segment indicia include one or more barcodes and each barcode is assigned a unique barcode identifier. The apparatus may further include means for determining the unique barcode identifier for each road segment indicia. The apparatus may further include means for matching the unique barcode identifier to a corresponding stored barcode identifier within the road segment indicia map database.

In some embodiments, the apparatus may further include means for generating a driving profile associated with a vehicle route, wherein (i) the driving profile comprises one or more driving profile attributes, (ii) each of the one or more driving profile attributes is associated with one or more road segment indicia, and (iii) the one or more driving profile attributes includes at least one of a speed profile, deceleration profile, acceleration profile, steering profile, or safety events. The apparatus may further include means for causing the driving profile to be provided to a road segment indicia server.

In some embodiments, the apparatus may further include means for identifying a distance between the vehicle and the one or more road segment indicia, wherein the means for estimating the location of the vehicle comprises means for refining the location of the vehicle within the lane of the road segment based at least in part on the respective distances between the vehicle and the one or more road segment indicia.

In some embodiments, the apparatus may further include means for detecting a road segment indicum is missing based at least in part upon the one or more data objects and the road segment indicia map database defining respective locations of a plurality of road segment indicia.

In some embodiments, the one or more road segment attributes include location information for the one or more road segment indicia. In some embodiments, the one or more sensors onboard the vehicle include one or more infrared sensors.

In an example embodiment, an apparatus includes processing circuitry, and at least one memory including computer program code, the at least one memory and the computer program code configured to, with the at least one processor, cause the apparatus at least to identify one or more road segment indicia based at least in part upon one or more data objects obtained by one or more sensors onboard the vehicle. The at least one memory and the computer program code may further be configured to, with the processing circuitry, cause the apparatus at least to determine one or more road segment attributes for the road segment upon which the vehicle is traveling based at least in part on the one or more identified road segment indicia and using a road segment indicia map database. The at least one memory and the computer program code may further be configured to, with the processing circuitry, cause the apparatus at least to estimate the location of the vehicle based at least in part upon the one or more road segment attributes.

The at least one memory and the computer program code may further be configured to, with the processing circuitry, cause the apparatus at least to access one or more driving profiles associated with the estimated location of the vehicle. The at least one memory and the computer program code may further be configured to, with the processing circuitry, cause the apparatus at least to determine one or more navigational instructions based at least in part on the one or more driving profile attributes for one or more driving profiles.

In some embodiments, the one or more road segment indicia include one or more barcodes and each barcode is assigned a unique barcode identifier. The at least one memory and the computer program code may further be configured to, with the processing circuitry, cause the apparatus at least to determine the unique barcode identifier for each road segment indicia. The at least one memory and the computer program code may further be configured to, with the processing circuitry, cause the apparatus at least to match the unique barcode identifier to a corresponding stored barcode identifier within the road segment indicia map database.

The at least one memory and the computer program code may further be configured to, with the processing circuitry, cause the apparatus at least to generate a driving profile associated with a vehicle route, wherein (i) the driving profile comprises one or more driving profile attributes, (ii) each of the one or more driving profile attributes is associated with one or more road segment indicia, and (iii) the one or more driving profile attributes includes at least one of a speed profile, deceleration profile, acceleration profile, steering profile, or safety events. The at least one memory and the computer program code may further be configured to, with the processing circuitry, cause the apparatus at least to cause the driving profile to be provided to a road segment indicia server.

The at least one memory and the computer program code may further be configured to, with the processing circuitry, cause the apparatus at least to identify a distance between the vehicle and the one or more road segment indicia. In this example embodiment, the at least one memory and the computer program code may further be configured to, with the processing circuitry, cause the apparatus to estimate the location of the vehicle by refining the location of the vehicle within the lane of the road segment based at least in part on the respective distances between the vehicle and the one or more road segment indicia.

The at least one memory and the computer program code may further be configured to, with the processing circuitry, cause the apparatus at least to detect a road segment indicum is missing based at least in part upon the one or more data objects and the road segment indicia map database defining respective locations of a plurality of road segment indicia.

In some embodiments, the one or more road segment attributes include location information for the one or more road segment indicia. In some embodiments, the one or more sensors onboard the vehicle include one or more infrared sensors.

In an example embodiment, a computer program product includes a computer program product comprising at least one non-transitory computer-readable storage medium having computer-executable program code portions stored therein, the computer-executable program code portions comprising program code instructions configured to identify one or more road segment indicia based at least in part upon one or more data objects obtained by one or more sensors onboard the vehicle. The computer-executable program code portions comprising program code instructions may further be configured to determine one or more road segment attributes for the road segment upon which the vehicle is traveling based at least in part on the one or more identified road segment indicia and using a road segment indicia map database. The computer-executable program code portions comprising program code instructions may further be configured to estimate the location of the vehicle based at least in part upon the one or more road segment attributes.

The computer-executable program code portions comprising program code instructions may further be configured to access one or more driving profiles associated with the estimated location of the vehicle. The computer-executable program code portions comprising program code instructions may further be configured to determine one or more navigational instructions based at least in part on the one or more driving profile attributes for one or more driving profiles.

In some embodiments, the one or more road segment indicia include one or more barcodes and each barcode is assigned a unique barcode identifier. The computer-executable program code portions comprising program code instructions may further be configured to determine the unique barcode identifier for each road segment indicia. The computer-executable program code portions comprising program code instructions may further be configured to match the unique barcode identifier to a corresponding stored barcode identifier within the road segment indicia map database.

The computer-executable program code portions comprising program code instructions may further be configured to generate a driving profile associated with a vehicle route, wherein (i) the driving profile comprises one or more driving profile attributes, (ii) each of the one or more driving profile attributes is associated with one or more road segment indicia, and (iii) the one or more driving profile attributes includes at least one of a speed profile, deceleration profile, acceleration profile, steering profile, or safety events. The computer-executable program code portions comprising program code instructions may further be configured to cause the driving profile to be provided to a road segment indicia server.

The computer-executable program code portions comprising program code instructions may further be configured to identify a distance between the vehicle and the one or more road segment indicia. In this example embodiment, the program code instructions configured to estimate the location of the vehicle comprise program code instructions configured to refine the location of the vehicle within the lane of the road segment based at least in part on the respective distances between the vehicle and the one or more road segment indicia.

The computer-executable program code portions comprising program code instructions may further be configured to detect a road segment indicum is missing based at least in part upon the one or more data objects and the road segment indicia map database defining respective locations of a plurality of road segment indicia.

In some embodiments, the one or more road segment attributes include location information for the one or more road segment indicia. In some embodiments, the one or more sensors onboard the vehicle include one or more infrared sensors.

In another example embodiment, a method includes maintaining a road segment indicia map database, wherein the road segment indicia map database is configured to store one or more road segment indicia identifiers and one or more corresponding road segment attributes for each road segment indicia identifier. The method may further include providing at least a portion of the road segment indicia map database to one or more vehicles.

In some embodiments, the method further includes maintaining a driving profile database, wherein (i) the driving profile database is configured to store one or more driving profiles, (ii) each driving profile comprises one or more profile attributes, (iii) each of the one or more driving profile attributes is associated with one or more road segment indicia, and (iv) the one or more driving profile attributes includes at least one of a speed profile, deceleration profile, acceleration profile, or steering profile. The method may further include providing at least a portion of the driving profile database to one or more vehicles.

In some embodiments, the method further includes updating one or more driving profiles in the driving profile database in response to receiving the one or more driving profiles from the one or more vehicles.

In some embodiments, the one or more road segment attributes include at least one or more of location information, lane attributes, speed attributes, deceleration attributes, acceleration attributes, or safety attributes. In some embodiments, the one or more road segment indicia identifiers each corresponds to a unique barcode identifier.

In another example embodiment, an apparatus includes means for maintaining a road segment indicia map database, wherein the road segment indicia map database is configured to store one or more road segment indicia identifiers and one or more corresponding road segment attributes for each road segment indicia identifier. The apparatus may further include means for providing at least a portion of the road segment indicia map database to one or more vehicles.

In some embodiments, the apparatus may further include means for maintaining a driving profile database, wherein (i) the driving profile database is configured to store one or more driving profiles, (ii) each driving profile comprises one or more profile attributes, (iii) each of the one or more driving profile attributes is associated with one or more road segment indicia, and (iv) the one or more driving profile attributes includes at least one of a speed profile, deceleration profile, acceleration profile, or steering profile. The apparatus may further include means for providing at least a portion of the driving profile database to one or more vehicles.

In some embodiments, the apparatus may further include means for updating one or more driving profiles in the driving profile database in response to receiving the one or more driving profiles from the one or more vehicles.

In some embodiments, the one or more road segment attributes include at least one or more of location information, lane attributes, speed attributes, deceleration attributes, acceleration attributes, or safety attributes. In some embodiments, the one or more road segment indicia identifiers each corresponds to a unique barcode identifier.

In an example embodiment, an apparatus includes processing circuitry, and at least one memory including computer program code, the at least one memory and the computer program code configured to, with the at least one processor, cause the apparatus at least to maintain a road segment indicia map database, wherein the road segment indicia map database is configured to store one or more road segment indicia identifiers and one or more corresponding road segment attributes for each road segment indicia identifier. The at least one memory and the computer program code may further be configured to, with the processing circuitry, cause the apparatus at least to provide at least a portion of the road segment indicia map database to one or more vehicles.

The at least one memory and the computer program code may further be configured to, with the processing circuitry, cause the apparatus at least to maintain a driving profile database, wherein (i) the driving profile database is configured to store one or more driving profiles, (ii) each driving profile comprises one or more profile attributes, (iii) each of the one or more driving profile attributes is associated with one or more road segment indicia, and (iv) the one or more driving profile attributes includes at least one of a speed profile, deceleration profile, acceleration profile, or steering profile. The at least one memory and the computer program code may further be configured to, with the processing circuitry, cause the apparatus at least to provide at least a portion of the driving profile database to one or more vehicles.

The at least one memory and the computer program code may further be configured to, with the processing circuitry, cause the apparatus at least to update one or more driving profiles in the driving profile database in response to receiving the one or more driving profiles from the one or more vehicles.

In some embodiments, the one or more road segment attributes include at least one or more of location information, lane attributes, speed attributes, deceleration attributes, acceleration attributes, or safety attributes. In some embodiments, the one or more road segment indicia identifiers each corresponds to a unique barcode identifier.

In an example embodiment, a computer program product includes at least one non-transitory computer-readable storage medium having computer-executable program code portions stored therein, the computer-executable program code portions comprising program code instructions configured to maintain a road segment indicia map database, wherein the road segment indicia map database is configured to store one or more road segment indicia identifiers and one or more corresponding road segment attributes for each road segment indicia identifier. The computer-executable program code portions comprising program code instructions may further be configured to provide at least a portion of the road segment indicia map database to one or more vehicles.

The computer-executable program code portions comprising program code instructions may further be configured to maintain a driving profile database, wherein (i) the driving profile database is configured to store one or more driving profiles, (ii) each driving profile comprises one or more profile attributes, (iii) each of the one or more driving profile attributes is associated with one or more road segment indicia, and (iv) the one or more driving profile attributes includes at least one of a speed profile, deceleration profile, acceleration profile, or steering profile. The computer-executable program code portions comprising program code instructions may further be configured to provide at least a portion of the driving profile database to one or more vehicles.

The computer-executable program code portions comprising program code instructions may further be configured to update one or more driving profiles in the driving profile database in response to receiving the one or more driving profiles from the one or more vehicles.

In some embodiments, the one or more road segment attributes include at least one or more of location information, lane attributes, speed attributes, deceleration attributes, acceleration attributes, or safety attributes. In some embodiments, the one or more road segment indicia identifiers each corresponds to a unique barcode identifier.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of a system that may be specifically configured to estimate the location of a vehicle in accordance with an example embodiment of the present disclosure;

FIG. 2 is an apparatus that may be specifically configured in accordance with an example embodiment of the present disclosure in order to estimate the location of a vehicle and which may embody, for example, the autonomous vehicle location estimation engine of FIG. 1 or a road segment indicia server;

FIG. 3 is a flowchart illustrating the operations performed, such as by the apparatus of FIG. 2, in order to estimate the location of a vehicle in accordance with an example embodiment of the present disclosure;

FIG. 4 is a flowchart illustrating the operations performed, such as by the apparatus of FIG. 2, for determining one or more road segment attributes for a road segment in accordance with an example embodiment of the present disclosure;

FIG. 5 is a flowchart illustrating the operations performed, such as by the apparatus of FIG. 2, for generating a driving profile in accordance with an example embodiment of the present disclosure;

FIG. 6 is a flowchart illustrating the operations performed, such as by the apparatus of FIG. 2, for maintaining a road segment indicia map database in accordance with an example embodiment of the present disclosure;

FIG. 7 is a flowchart illustrating the operations performed, such as by the apparatus of FIG. 2, for maintaining a driving profile database in accordance with an example embodiment of the present disclosure; and

FIG. 8 illustrates the location of a vehicle relative to road sign indicia on a road segment in accordance with an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

As mentioned above, vehicles, such as autonomous vehicles, are capable of identifying their location in line-of-sight situations utilizing satellite-based navigation and then map matching their location to a road segment defined by a map. In some situations, however, the GNSS receiver can no longer maintain a line-of-sight with the satellites and, as such, may not provide a stable and accurate estimate of the location of the vehicle. For example, the GNSS receivers carried by vehicles driving through urban canyons in downtown areas in which a vehicle is surrounded by tall buildings or vehicles driving in a forested region may be unable to maintain a line-of-sight with the navigation system satellites and prevent stable location estimation. In such situations, the vehicle may include a radio frequency (RF) receiver to receive radio signals from which the location the vehicle may be estimated. These RF signals may include cellular signals, such as global system for mobile communications (GSM) signals, wideband code division multiple access (WCDMA) signals, long term evolution (LTE) signals, wireless local area network (WLAN) signals and/or Bluetooth signals. In combination, these various types of radio signals may be analyzed to estimate location of the RF receiver and, in turn, the vehicle carrying the RF receiver. However, the location may only be estimated with an accuracy of about 50 meters and, in instances in which only cellular signals are utilized, the accuracy of the location estimation degrades to hundreds of meters or even more. Such location estimation is generally insufficient for purposes of establishing the location of a vehicle for navigational purposes as the limited accuracy may prevent the road segment on which the vehicle is traveling from being identified with sufficient confidence and, in any event, may prevent the lane of the road segment upon which the vehicle is traveling from being identified since the width of many vehicle lanes is typically four meters or less. Other sensors, such as inertial measurement units (IMUs) can increase the accuracy of localization by taking into account vehicle movement, but these sensors may drift and fail to provide sufficient accuracy to ensure maximum safety. As such, navigation of a vehicle, such as an autonomous vehicle for which navigation requires localization accuracy to within, for example, 10 centimeters, may be limited in instances in which the GNSS receiver cannot maintain a line-of-sight with the navigation system satellites.

As discussed herein, a method, apparatus and computer program product are provided which address the various shortcomings of current satellite-based navigation and then map matching. In this regard, the method, apparatus and computer program product may estimate the location of a vehicle based at least in part upon one or more road segment indicia depicted in one or more received data objects captured by one or more sensors onboard the vehicle, such as one or more infrared sensors. A road segment indicia map database may be used to determine one or more road segment attributes based at least in part on the one or more road segment indicia. The location of the vehicle may then be estimated based at least in part upon the one or more road segment attributes. By relying at least in part upon the one or more road segment indicia, the location of the vehicle may be estimated more accurately, thereby providing for increased confidence in and reliability of the navigation of the vehicle, particularly in scenarios where traditional methods (e.g., GNSS) for vehicle location determination are inaccurate and/or insufficient. In this regard, the vehicle may be an autonomous vehicle and the increased accuracy with which the location of the autonomous vehicle is estimated may improve the confidence with which the autonomous vehicle and/or other vehicles in the vicinity of the autonomous vehicle may be navigated.

Furthermore, in some embodiments, the location of the vehicle may further correspond to a particular driving profile indicative of one or more driving profile attributes which may be used when determining one or more navigational instructions for the vehicle at the particular location. For example, the one or more navigational instructions may include a recommended speed, deceleration profile, acceleration profile, steering profile, and/or the like. As such, the vehicle may be operated and/or navigated in accordance with a recommended driving profile for the particular location, thus leading to safer vehicle navigation for the vehicle, vehicle occupants, pedestrians, and/or surrounding vehicles.

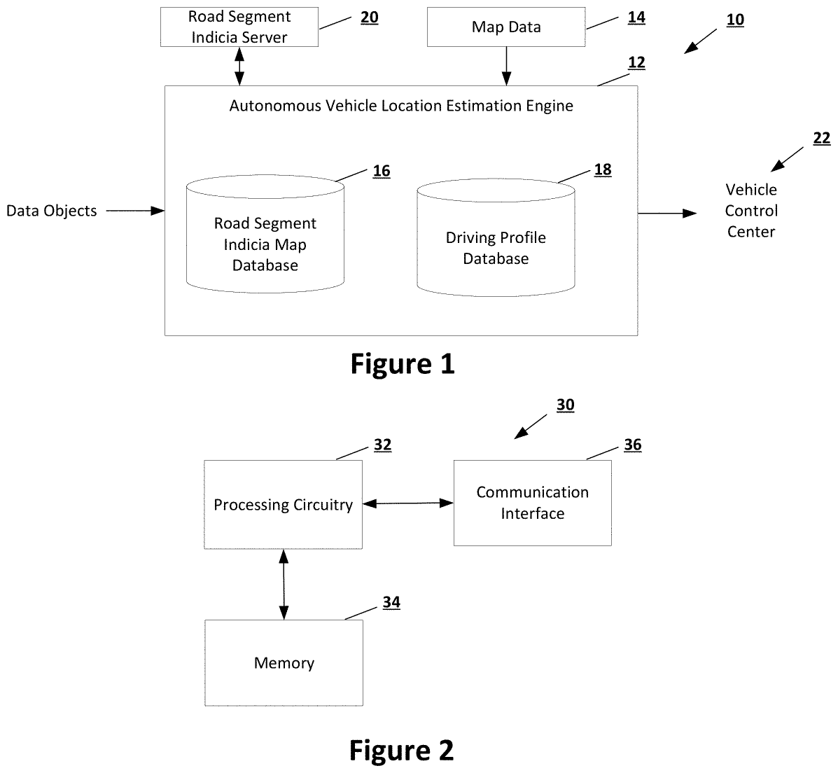

By way of example, a system 10 configured to estimate the location of a vehicle, such as, but not limited to an autonomous vehicle, is depicted in FIG. 1. As shown, the system of this example embodiment includes an autonomous vehicle location estimation engine 12 that is configured to estimate the location of a vehicle. The autonomous vehicle location estimation engine may be onboard and embodied by a computing device carried by the autonomous vehicle. For example, the autonomous vehicle location estimation engine may be embodied by the engine control module (ECM) of the autonomous vehicle. Alternatively, the autonomous vehicle location estimation engine may be offboard, but in communication with the autonomous vehicle, such as in instances in which an edge computing device embodies the autonomous vehicle location estimation engine.

The autonomous vehicle location estimation engine 12 receives information captured by one or more sensors. In some embodiments, the information received by the autonomous vehicle location estimation engine may include one or more data objects captured by one or more sensors, such as one or more infrared sensors, onboard the vehicle and/or information regarding one or more road segment indicia captured by the one or more sensors onboard the vehicle in instances in which the one or more data objects have been processed so as to identify the one or more road segment indicia prior to provision of the information to the autonomous vehicle location estimation engine. In some embodiments, this information may include GPS or other navigation satellite system data captured by a GNSS or other satellite receiver onboard the vehicle. Additionally, or alternatively, the information received by the autonomous vehicle location estimation engine may include cellular, Wi-Fi, Bluetooth or other radio signals received by an RF receiver onboard the vehicle.

As indicated by the types of information provided to the autonomous vehicle location estimation engine 12, the vehicle for which the location is to be estimated may include one or more different types of sensors. In some embodiments, the vehicle may include one or more infrared sensors and/or the like to capture one or more road segment indicia as one or more data objects. For example, road segment indicia may be invisible 2-dimensional barcodes that are detectable by the one or more infrared sensors onboard the vehicle. The sensors may have fields of view that extend in various directions relative to the vehicle. For example, the sensors carried by the vehicle may include a front sensor having a field of view that extends forward and to the sides of the vehicle and a rear sensor having a field of view extends rearward and to the sides of the vehicle. In some embodiments, the vehicle may include a GNSS or other satellite receiver for receiving GPS, GLONASS, Galileo, BeiDou, Compass or other navigation satellite signals. Additionally, or alternatively, the autonomous vehicle may include an RF receiver configured to receive cellular signals, Wi-Fi signals, Bluetooth signals or other radio signals. Still further, the vehicle may include one or more image capture devices, such as cameras, including cameras for capturing still images and/or video recording devices for capturing video images. The image capture devices may also have fields of view that extend in various directions relative to the vehicle. For example, the image capture devices carried by the vehicle may include a front camera having a field of view that extends forward and to the sides of the vehicle and a rear camera having a field of view extends rearward and to the sides of the vehicle. The vehicle of other embodiments may carry additional cameras having different fields of view, such as fields of view to the opposed sides of the vehicle.

In some embodiments, the autonomous vehicle location estimation engine 12 may be communicatively coupled to a road segment indicia server 20. The road segment indicia server may be configured to store a master road segment indicia map database and/or master driving profile database. In some embodiments, the autonomous vehicle location estimation engine 12 may request at least a portion of the master road segment indicia map database and/or master driving profile database from the road segment indicia server 20. The requested portion of the master road segment indicia map database and/or master driving profile database may be based at least in part on an origin location for the vehicle, destination location for the vehicle, one or more particular routes that may traversed between the origin location and destination location, and/or the like. In some embodiments, the autonomous vehicle location estimation engine 12 may be configured to generate a driving profile, such as during a vehicle trip, and may provide the generated driving profile to the road segment indicia server 20. The road segment indicia server 20 may update one or more driving profiles stored within the master driving profile database based at least in part on the provided driving profile. As such, the one or more driving profiles may be continuously updated such that the driving profiles are accurate and up-to-date.

As also shown in FIG. 1, the system 10 for estimating the location of a vehicle also includes a source 14 of map data, such as high-definition map data defining road segment geometry for a road network. The autonomous vehicle location estimation engine 12 of this example embodiment may also include one or more databases including a road segment indicia map database 16. The road segment indicia map database identifies each of a plurality of road segment indicia throughout the road network and includes one or more road segment attributes for the road segment indicum. The road segment attributes may include location information. The location information may include the location of each of the respective road segment indicum. The location of each respective road segment indicum may be indicated by precise GPS coordinate set (e.g., latitude, longitude, and/or altitude) or a cartesian set (e.g., an x coordinate, y coordinate, and/or z coordinate). Although illustrated so as to include the various databases, the autonomous vehicle location estimation engine need not include any one or more of the databases and may, instead, be in communication with one or more external databases. In some embodiments, each road segment indicum may be mapped to one or more driving profiles in a driving profile database 18. The one or more mapped driving profiles may correspond to the location described by the particular road segment indicum. The road segment indicia map database may be at least a portion of a master road segment indicia map database which may be stored by a road segment indicia server 20.

In some embodiments, as shown in FIG. 1, the system 10 for estimating the location of a vehicle of an example embodiment may include a driving profile database 18. The driving profile database 18 may be configured to store one or more driving profiles for one or more vehicles. Each driving profile may be associated with one or more road segment indicia, such as by mapping the driving profile to the particular road segment indicium within the road segment indicia map database 16. Each driving profile may include one or more driving profile attributes where driving attributes may describe lane attributes (e.g., a lane number, left lane or right lane, merging lane, and/or the like), speed attributes (e.g., a recommended speed), deceleration attributes (e.g., a deceleration profile), acceleration attributes (e.g., an acceleration profile), and/or safety attributes (e.g., safety information and/or event information), and/or the like. In some embodiments, each driving profile may correspond to a particular vehicle. The driving profile may be associated with a unique identifier for each vehicle and may further include driving profile metadata such as a vehicle make, model, year, body style, trim level, and/or the like. In some embodiments, a driving profile may correspond to a particular class of vehicles. For example, a driving profile may correspond to four-wheel drive trucks, such as by averaging one or more vehicle driving profiles associated with four-wheel drive trucks to generate the four-wheel drive truck driving profile. Another driving profile may correspond to a particular vehicle model, such as by averaging one or more vehicle driving profiles associated with the vehicle model to generate the vehicle model driving profile. In some embodiments, a single driving profile may correspond to a particular location. For example, the single driving profile may be determined based at least in part on one or more vehicle driving profiles, such as by averaging the one or more vehicle driving profiles to generate the single driving profile. The driving profile database 18 may be at least a portion of a master driving profile database which may be stored by a road segment indicia server 20.

As shown in FIG. 1, the system 10 for estimating the location of a vehicle of this example embodiment may also be configured to communicate with an autonomous vehicle control center 22. In this regard, the autonomous vehicle location estimation engine 12 may estimate the location of the vehicle, such as in the manner described below, and may provide an indication of the estimated location to the autonomous vehicle control center. In some embodiments, the autonomous vehicle location estimation engine 12 may also determine one or more driving profiles corresponding to the one or more road segment indicia and provide one or more driving profile attributes to the autonomous vehicle control center 22. The autonomous vehicle control center may, in turn, track the location of the autonomous vehicle and may provide navigational directions to the autonomous vehicle and/or to other vehicles in the proximity of the autonomous vehicle based upon the location estimated for the autonomous vehicle and/or the one or more driving profile attributes.

Referring now to FIG. 2, an apparatus 30 is depicted that may be specifically configured in order to estimate the location of a vehicle. In this regard, the apparatus may embody the autonomous vehicle location estimation engine 12 of FIG. 1 and may, in turn, be embodied by any of a variety of different computing devices including, for example, an edge computing device offboard the vehicle or a computing device onboard the vehicle, such as an ECM. In some embodiments, the remote server may be a road segment indicia server. Although the edge computing device may be configured to estimate the location of a vehicle, the edge computing device of an example embodiment collaborates with a computing device onboard the vehicle, such as the ECM, in that the edge computing device trains a model to identify road segment indicia and then causes the model to be provided to a computing device onboard the vehicle, such as the ECM, to permit identification of each of the one or more road segment indicia as described below. Regardless of the type of computing device that embodies the apparatus, the apparatus of this example embodiment includes, is associated with or is in communication with processing circuitry 32, memory 34 and communication interface 36.

In some embodiments, the processing circuitry 32 (and/or co-processors or any other processors assisting or otherwise associated with the processing circuitry) may be in communication with the memory device 34 via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processing circuitry.

The processing circuitry 32 may be embodied in a number of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processor may enable multiprocessing within a single physical package. Additionally or alternatively, the processing circuitry may include one or more processors configured in tandem via the bus to enable independent execution of instructions, pipelining and/or multithreading.

In an example embodiment, the processing circuitry 32 may be configured to execute instructions stored in the memory device 34 or otherwise accessible to the processing circuitry. Alternatively or additionally, the processing circuitry may be configured to execute hard coded functionality. As such, whether configured by hardware or software methods, or by a combination thereof, the processing circuitry may represent an entity (for example, physically embodied in circuitry) capable of performing operations according to an embodiment of the present invention while configured accordingly. Thus, for example, when the processing circuitry is embodied as an ASIC, FPGA or the like, the processing circuitry may be specifically configured hardware for conducting the operations described herein. Alternatively, as another example, when the processing circuitry is embodied as an executor of software instructions, the instructions may specifically configure the processing circuitry to perform the algorithms and/or operations described herein when the instructions are executed. However, in some cases, the processing circuitry may be a processor of a specific device (for example, a computing device) configured to employ an embodiment of the present invention by further configuration of the processor by instructions for performing the algorithms and/or operations described herein. The processing circuitry may include, among other things, a clock, an arithmetic logic unit (ALU) and logic gates configured to support operation of the processing circuitry.

The apparatus 30 of an example embodiment may also optionally include a communication interface 36 that may be any means such as a device or circuitry embodied in either hardware or a combination of hardware and software that is configured to receive and/or transmit data from/to other electronic devices in communication with the apparatus, such as a navigation system or other consumer of map data. Additionally or alternatively, the communication interface may be configured to communicate in accordance with various wireless protocols including GSM, such as but not limited to LTE. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s).

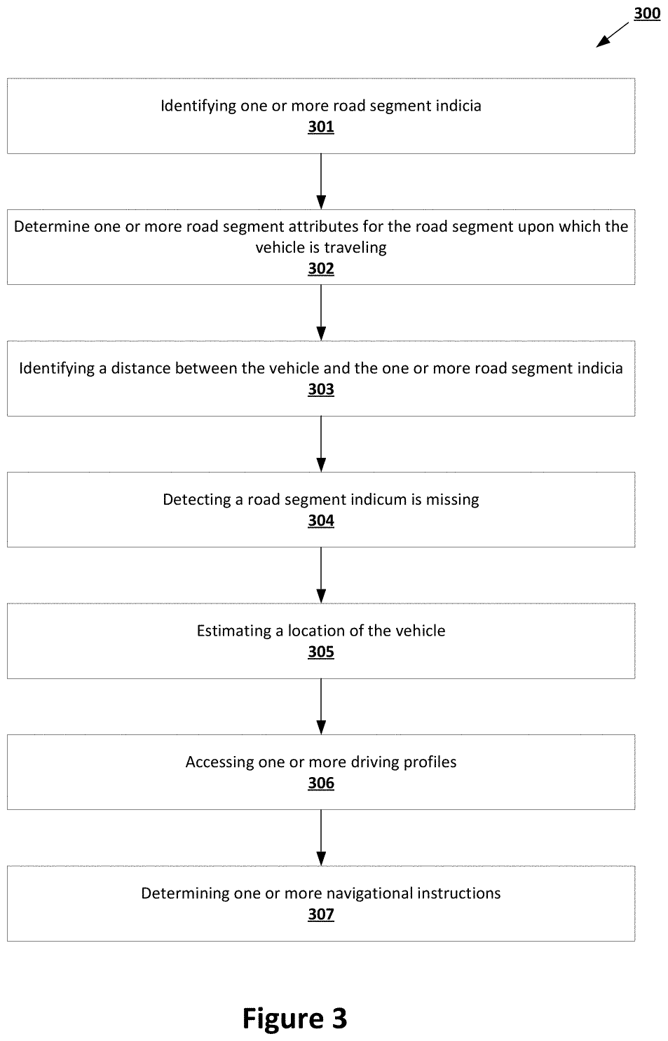

Referring now to FIG. 3, the operations performed, such as by the apparatus 30 of FIG. 2, in accordance with an example embodiment in order to determine the location of a vehicle are depicted.

At block 301 of FIG. 3, the apparatus 30 embodied by a computing device, such as autonomous vehicle location estimation engine 12 includes means, such as the processing circuitry 32, communication interface 36, or the like, for identifying one or more road segment indicia. In some embodiments, the one or more road segment indicia may be identified based at least in part upon one or more data objects obtained by one or more sensors onboard the vehicle. By way of example, the vehicle is described herein as an autonomous vehicle which may, in turn, be a fully autonomous vehicle or a partly autonomous vehicle. Alternatively, the vehicle need not be autonomous, but may be manually operated. Regardless of the type of vehicle, the data objects obtained by the vehicle may be obtained using one or more sensors onboard the vehicle having respective fields of view that depict the area in proximity to the current location of the vehicle, such as images forward and to both sides of the road captured by a forwardly facing camera and images rearward and to both sides of the road captured by a rearwardly facing camera of the vehicle. The road segment indicia may be disposed at predefined locations along a road segment. For example, the road segment indicia may include, for example, two-dimensional barcode, that are disposed at predefined locations, such as every mile, every 20 meters along the road segment, etc. Furthermore, the road segment indicia may be placed anywhere on the road segment, such as within a particular road segment lane, along lane lines, along boundary lines, and/or the like.

The one or more sensors onboard the vehicle may be infrared sensors configured to scan a road segment and detect road segment indicia. In some embodiments, in the event an infrared sensor detects road segment indicia, a data object may be generated, such as by a computing device onboard the vehicle, which describes the road segment indicia, such as by a unique road segment indicia identifier.

At block 302 of FIG. 3, the apparatus 30 embodied by a computing device, such as autonomous vehicle location estimation engine 12 includes means, such as the processing circuitry 32, memory 34, or the like, for determining one or more road segment attributes for the road segment upon which the vehicle is traveling. In some embodiments, the one or more road segment attributes may be determined based at lest in part on the one or more identified road segment indicia and using a road segment indicia map database. The one or more road segment attributes include at least location information for the one or more road segment indicia. The location information may include the location of each of the respective road segment indicum. For example, the location of each respective road segment indicum may be indicated by a precise GPS coordinate set (e.g., latitude, longitude, and/or altitude) or a cartesian set (e.g., an x coordinate, y coordinate, and/or z coordinate).

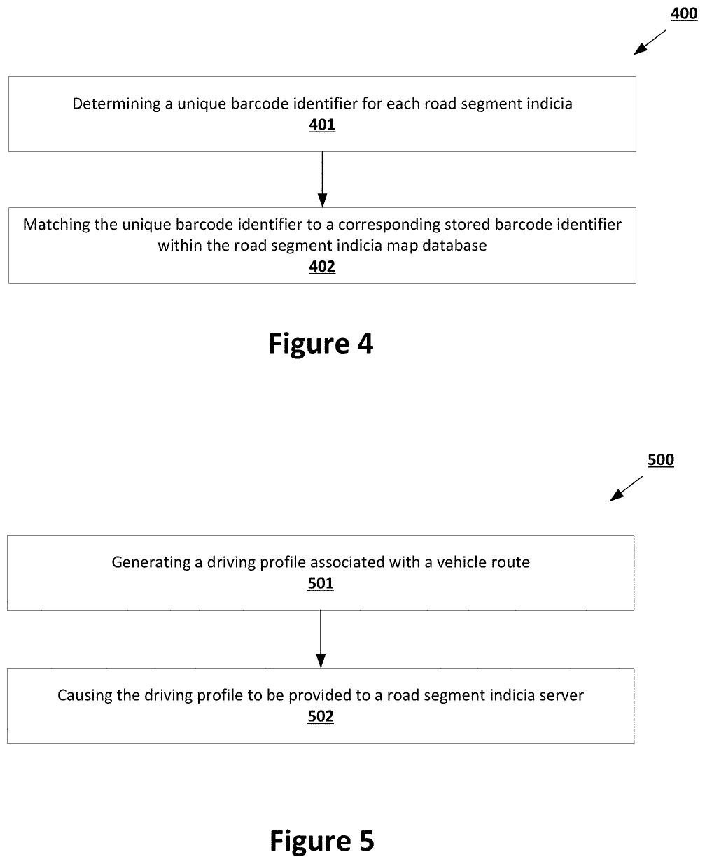

In some embodiments, block 302 may be performed in accordance with the various steps/operations of the process 400 depicted in FIG. 4, which is a flowchart diagram of an example process for determining the one or more road segment attributes.

At block 401 of FIG. 4, the apparatus 30 embodied by a computing device, such as autonomous vehicle location estimation engine 12 includes means, such as the processing circuitry 32, communication interface 36, or the like, for determining a unique barcode identifier for each road segment indicia. In some embodiments, the one or more road segment indicia are two-dimensional barcodes which each corresponds to a unique barcode identifier. The one or more data objects obtained by one or more sensors onboard the vehicle may describe the unique barcode identifier as detected by the one or more sensors. For example, the one or more sensors onboard the vehicle may be infrared sensors configured to scan a road segment and detect road segment indicia. In some embodiments, in the event an infrared sensor detects road segment indicia, a data object may be generated, such as by a computing device onboard the vehicle, which describes the road segment indicia, such as by a unique road segment indicia identifier. The one or more data objects may also describe a timestamp at which point each road segment indicum was detected.

At block 402 of FIG. 4, the apparatus 30 embodied by a computing device, such as autonomous vehicle location estimation engine 12 includes means, such as the processing circuitry 32, memory 34, or the like, for matching the unique barcode identifier to a corresponding stored barcode identifier within the road segment indicia map database. The road segment indicia map database may store the one or more road segment attributes for a particular road segment indicum, which corresponds to a road segment indicia identifier. In some embodiments, the road segment indicia identifier is the barcode identifier for the two-dimensional barcode (i.e., road segment indicum). The autonomous vehicle location estimation engine 12 may be configured to match the one or more barcode identifiers described by the one or more data objects to the barcode identifiers within the road segment indicia map database. Once the unique barcode identifier has been matched to the stored barcode identifier within the road segment indicia map database, the autonomous vehicle location estimation engine 12 may be configured to determine the one or more road segment attributes for the road segment.

Returning now to FIG. 3, at block 303, the apparatus 30 embodied by a computing device, such as autonomous vehicle location estimation engine 12 includes means, such as the processing circuitry 32, the like, for identifying a distance between the vehicle and the one or more road segment indicia. In some embodiments, the autonomous vehicle location estimation engine 12 may be configured to determine the distance between the vehicle and a respective road segment indicum detected by a sensor in various manners. In some embodiments, the detection range of the one or more sensors onboard the camera may be used in part to determine the distance between the vehicle and the road segment indicum. For example, an infrared sensor onboard the vehicle and positioned to have a field of view extending in front of the vehicle may have a detection range of 5 meters. As such, upon detection of the road segment indicum by the infrared sensor onboard the vehicle, the road segment indicum can be estimated to be 5 meters from the vehicle.

In some embodiments, the distance between the vehicle and the one or more road segment indicia may be determined based at least in part on the vehicle speed. By way of continuing example, upon detection of the road segment indicum by the infrared sensor onboard the vehicle, the road segment indicum can be estimated to be 5 meters from the vehicle. The vehicle may be traveling at 50 miles per hour (mph) at the time of detection. As such, the distance between the vehicle and a road segment indicum may be determined over time based at least in part on the speed the vehicle is traveling. As such, the position of the vehicle relative to the one or more road segment indicia may be determined.

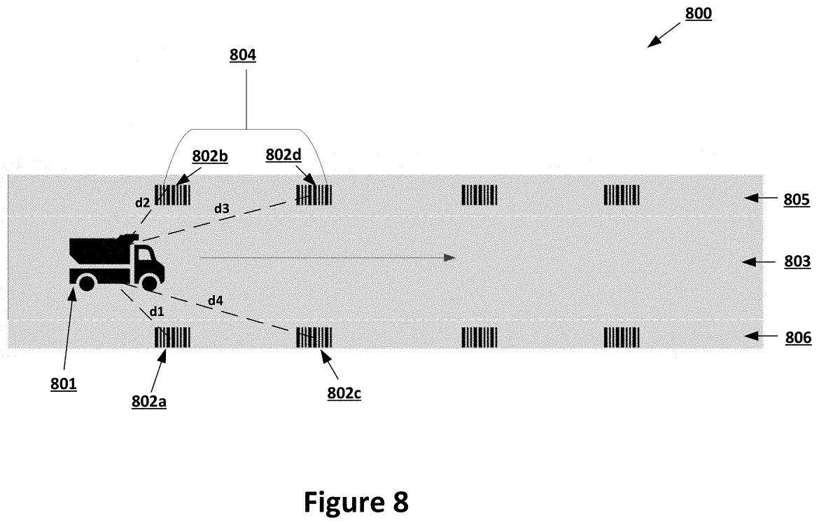

By way of example and as shown in FIG. 8, the one or more road segment indicia captured by one or more sensors onboard a vehicle 801 traveling in a lane 803 include four two-dimensional barcodes 802a-d spaced from one another along one side of the road segment along which the vehicle is traveling. In this example embodiment, the two-dimensional barcodes 802b and 802d are placed within a lane 805 and the two-dimensional barcodes 802a and 802c are disposed within a lane 806. In this example embodiment, the apparatus 30, such as the processing circuitry 32, is configured to separately determine the distance from the vehicle to each of the four two-dimensional barcodes. For example, the apparatus, such as the processing circuitry, determines the distance to two-dimensional barcode 802a to be d1, the distance to two-dimensional barcode 802b to be d2, the distance to two-dimensional barcode 802c to be d3, and the distance to two-dimensional barcode 802d to be d4.

Furthermore, the location of each two-dimensional barcode is known as determined using the road segment indicia map database. As such, the distance between two or more road segment indicia is also known. For example, the two-dimensional barcode 802b may correspond to a location designated by the cartesian coordinates (0, 0, 0) and the two-dimensional barcode 802d may correspond to a location designated by the cartesian coordinates (20, 0, 0). As such the distance 804 between the two-dimensional barcodes 802b and 802d may be determined.

Furthermore, the apparatus, such as the processing circuitry 32, may also be configured to receive data object metadata associated with the one or more data objects, such as timestamp at which time the data object was generated and/or each road segment indicum was detected, the speed of the vehicle at the time the data object was generated and/or each road segment indicum was detected and/or the like.

At block 304 of FIG. 3, the apparatus 30 embodied by a computing device, such as autonomous vehicle location estimation engine 12 includes means, such as the processing circuitry 32, memory 34, or the like, for detecting a road segment indicia is missing. In some embodiments, the autonomous vehicle location estimation engine 12 may predict one or more upcoming road segment indicia using the road segment indicia map database and based at least in part on one or more identified road segment indicia. For example, referring back to FIG. 8, the autonomous vehicle location estimation engine 12 may detect two-dimensional barcode 802b and determine that two-dimensional barcode 802d, two-dimensional barcode 802a, and/or two-dimensional barcode 802c should also be detected. The autonomous vehicle location estimation engine may be configured to compare the one or more road segment indicia that were identified and one or more road segment indicia that should have been detected by the one or more sensors onboard the vehicle. In an instance in which one or more road segment indicia that should have been detected within the field of view of a respective sensor device were not actually identified by the one or more data objects, the apparatus 30, such as the processing circuitry 32, is configured to detect that a road segment indicum is missing. This information regarding a road segment indicum that is missing, including information regarding the location of the road segment indicum that is missing, may be provided or reported, such as to the Department of Transportation or other road authority responsible for maintenance of the road network and the road segment indicia therealong.

At block 305 of FIG. 3, the apparatus 30 embodied by a computing device, such as autonomous vehicle location estimation engine 12 includes means, such as the processing circuitry 32, memory 34, or the like, for estimating a location of the vehicle. The location of the vehicle may be based at least in part upon the one or more road segment attributes, such as the location information for the one or more road segment indicia. For example, the infrared sensor onboard the vehicle may have a detection range of 5 meters. As such, upon detection of the road segment indicum by the infrared sensor onboard the vehicle, the road segment indicum can be estimated to be 5 meters from the vehicle such that the location of the vehicle is within 5 meters of the location described by the road segment attributes corresponding to the detected road segment indicum.

In some embodiments, the apparatus 30, such as the processing circuitry 32, may refine the location of the vehicle based upon the respective distances between the vehicle and the one or more road segment indicia. In some embodiments, the autonomous vehicle location estimation engine 12 may refine the location of the vehicle within the lane of the road segment based at least in part on the respective distances between the vehicle and the one or more road segment indicia in the manner described above. For example, referring back to FIG. 8, a vehicle traveling in lane 803 may detect two-dimensional barcode 802a using the one or more onboard sensors and the autonomous vehicle location estimation engine 12 may determine the distance d1 corresponding to the distance between the vehicle and two-dimensional barcode 802a is 3 meters. As another example, a vehicle traveling in lane 805 may detect two-dimensional barcode 802a using the one or more onboard sensors and the autonomous vehicle location estimation engine 12 may determine the distance d1 corresponding to the distance between the vehicle and two-dimensional barcode 802a is 10 meters. As such, the autonomous vehicle location estimation engine 12 may determine the respective lane of the road segment the vehicle is traveling based at least in part on the respective distance between the vehicle and the one or more road segment indicia.

In some embodiments, the location of the vehicle may additionally or alternatively be refined based at least in part on which road segment indicia are detected and included within the one or more data objects. For example, referring back to FIG. 8, a vehicle traveling in the lane 805 may detect two-dimensional barcodes 802b and 802d using the one or more onboard sensors but may not detect the two-dimensional barcodes 802a and 802c. As such, the autonomous vehicle location estimation engine 12 may determine the vehicle is in lane 805. As another example, a vehicle traveling in the lane 803 may detect two-dimensional barcodes 802a-802d using the one or more onboard sensors. As such, the autonomous vehicle location estimation engine 12 may determine the vehicle is in lane 803.

At block 308 of FIG. 3, the apparatus 30 embodied by a computing device, such as autonomous vehicle location estimation engine 12 includes means, such as the processing circuitry 32, memory 34, or the like, for accessing one or more driving profiles. A driving profile database may be configured to store one or more driving profiles for one or more vehicles. Each driving profile may be associated with one or more road segment indicia, such as by mapping the driving profile to the particular road segment indicium within the road segment indicia map database 16. Each driving profile may include one or more driving profile attributes such as one or more lane attributes (e.g., a lane number, left lane or right lane, merging lane, and/or the like), speed attributes (e.g., a recommended speed), deceleration attributes (e.g., a deceleration profile), acceleration attributes (e.g., an acceleration profile), and/or safety attributes (e.g., safety information and/or event information), and/or the like. In some embodiments, each driving profile may correspond to a particular vehicle. The driving profile may be associated with a unique identifier for each vehicle and may further include driving profile metadata such as a vehicle make, model, year, body style, trim level, and/or the like. In some embodiments, a driving profile may correspond to a particular class of vehicles. For example, a driving profile may correspond to four-wheel drive trucks, such as by averaging one or more vehicle driving profiles associated with four-wheel drive trucks to generate the four-wheel drive truck driving profile. As another example, the driving profile may correspond to a particular vehicle model, such as by averaging one or more vehicle driving profiles associated with the vehicle model to generate the vehicle model driving profile. In some embodiments, a single driving profile may correspond to a particular location. For example, the single driving profile may be determined based at least in part on one or more vehicle driving profiles, such as by averaging the one or more vehicle driving profiles to generate the single driving profile.

At block 307 of FIG. 3, the apparatus 30 embodied by a computing device, such as autonomous vehicle location estimation engine 12 includes means, such as the processing circuitry 32, memory 34, or the like, for determining one or more navigational instructions. Once the location of the vehicle has been determined, the location may be utilized in part for navigation and/or mapping purposes. The one or more navigational instructions may be displayed and/or audibly announced using one or more onboard devices. In some embodiments, the one or more navigational instructions may be based at least In part on the one or more driving profiles. For example, the one or more navigational instructions may include a recommended speed, deceleration rate, acceleration rate, steering instructions, and/or safety instructions for the particular vehicle location.

With respect to a manually operated vehicle including a navigation system, the location of the vehicle may be provided to the navigation and/or mapping system in order to permit the location of the vehicle to be more accurately represented upon a map presented by the mapping system and/or to provide more accurate navigation information via the navigation system. Alternatively, in relation to either a manually operated vehicle or an autonomous vehicle, the location of the vehicle may be reported to a control center, such as offboard the vehicle. Based upon the location of the vehicle, the control center may provide navigational directions to the vehicle, such as may be presented via a navigation system to the driver of a manually operated vehicle or that may more directly control the navigation of an autonomous vehicle. By utilizing the more accurate location of the vehicle that is provided in accordance with an example embodiment, the vehicle may be navigated with more precision and reliability and correspondingly, other vehicles in the proximity of the vehicle may also be navigated in a more reliable manner armed with more accurate location information for the vehicle.

Referring now to FIG. 5, the operations performed, such as by the apparatus 30 of FIG. 2, in accordance with an example embodiment in order to generate a driving profile associated with the vehicle route are depicted.

At block 501 of FIG. 5, the apparatus 30 embodied by a computing device, such as autonomous vehicle location estimation engine 12 includes means, such as the processing circuitry 32, memory 34, or the like, for generating a driving profile associated with a vehicle route. The driving profile may include information pertaining to the vehicle with reference to one or more particular road segment indicia. For example, the driving profile may include one or more driving profile attributes such as a speed profile, deceleration profile, acceleration profile, steering profile, or safety events based at least in part on the operation of the vehicle for the duration the road segment indicia is detected and/or remains detected.

At block 502 of FIG. 5, the apparatus 30 embodied by a computing device, such as autonomous vehicle location estimation engine 12 includes means, such as the processing circuitry 32, memory 34, or the like, for causing the driving profile to be provided to a remote server, such as a road segment indicia server. As such, the road segment indicia server may use the driving profile to update one or more driving profiles stored within a master driving profile database. In this way, the one or more driving profiles may be accurately maintained and updated in real-time and/or near real-time.

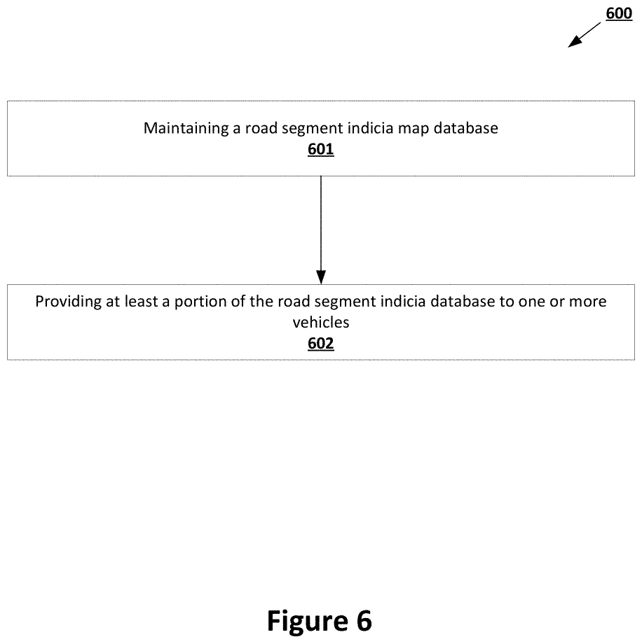

Referring now to FIG. 6, the operations performed, such as by the apparatus 30 of FIG. 2, in accordance with an example embodiment in order to maintain a road segment indicia map database are illustrated. In some embodiments, the apparatus 30 may be embodied by a remote server, such as a road segment indicia server. The road segment indicia server may be configured to store a master road segment map indicia map database and/or master driving profile database. In some embodiments, the road segment indicia server may provide at least a portion of the master road segment indicia map database and/or driving profile database to an autonomous vehicle location estimation engine, which may be embodied by any of a variety of different computing devices including, for example, an edge computing device offboard the vehicle or a computing device onboard the vehicle, such as an ECM. The road segment indicia server may be configured to maintain an accurate and up-to-date road segment indicia map database and/or driving profile database.

At block 601 of FIG. 6, the apparatus 30 embodied by a computing device, such as the road segment indicia server includes means, such as the processing circuitry 32, memory 34, or the like, for maintaining a road segment indicia map database. In some embodiments, the road segment indicia map database may be a master road segment indicia map database. In some embodiments, the road segment indicia server may be configured to generate the master road segment indicia database by populating the master road segment indicia database with one or more road segment indicia identifiers and corresponding road segment attributes. The one or more road segment indicia identifiers may be one or more unique barcode identifiers and the one or more road segment attributes may include location information for a corresponding road segment indicum. In the event the location of road segment indicia is moved from one location to another and/or removed entirely, the road segment indicia server may be configured to update the master road segment indicia map database accordingly. For example, if one or more vehicles detect a road segment indicum is missing, as described at block 304 of FIG. 3, the road segment indicia map database may be configured to remove the corresponding road segment indicia identifier and one or more road segment attributes from the master road segment indicia map database. In some embodiments, the road segment indicia server may remove the corresponding road segment indicia identifier and one or more road segment attributes from the master road segment indicia map database in an instance a missing road segment indicum reporting count threshold is satisfied. For example, a missing road segment indicum reporting count threshold is satisfied may be 20 missing road segment indicum reporting counts within a one hour time-frame such that if 20 vehicles report a missing road segment indicum within a one hour time frame, the road segment indicia server may remove the corresponding road segment indicia identifier and one or more road segment attributes from the master road segment indicia map database. Otherwise, the road segment indicia server may maintain the road segment indicia identifier and one or more road segment attributes within the master road segment indicia map database. In this way, this may prevent road segment indicia from being erroneously removed from the master road segment indicia map database. As such, the master road segment indicia map database may be accurate and up-to-date.

At block 602 of FIG. 6, the apparatus 30 embodied by a computing device, such as the road segment indicia server includes means, such as the processing circuitry 32, memory 34, communication interface 36 or the like, for providing at least a portion of the road segment indicia database to one or more vehicles. In some embodiments, the road segment indicia server may receive one or more requests from one or more vehicles for at least a portion of a road segment indicia database. The request for at least a portion of the road segment indicia database may be based at least in part on the origin location for the vehicle, destination location for the vehicle, one or more particular routes that may traversed between the origin location and destination location, and/or the like. The road segment indicia server may then provide the requested portion of the road segment indicia database to the one or more requesting vehicles, such that the vehicles may access the portion of the road segment indicia database even when not in communication with the road segment indicia server.

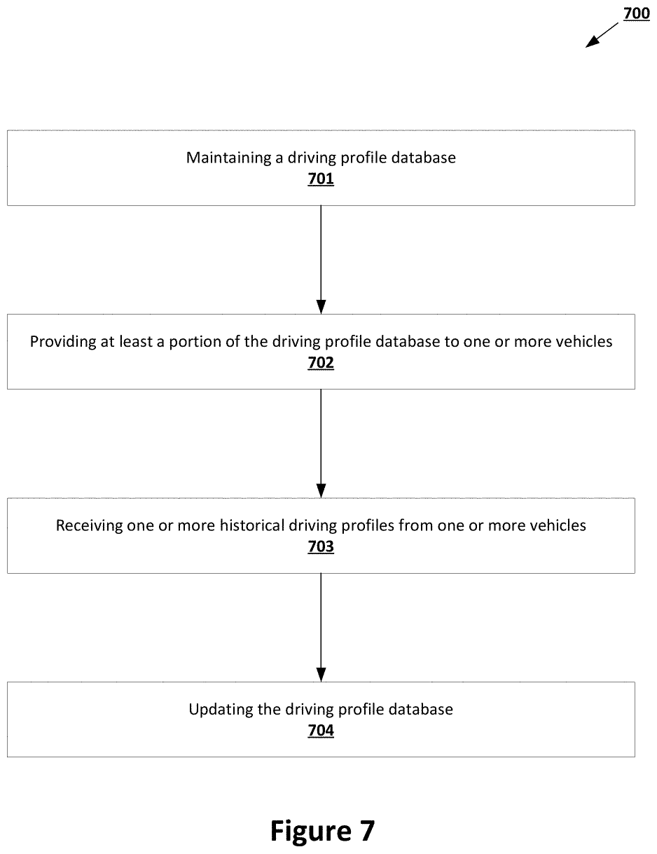

Referring now to FIG. 7, the operations performed, such as by the apparatus 30 of FIG. 2, in accordance with an example embodiment in order to maintain a road segment indicia map database are illustrated. In some embodiments, the apparatus 30 may be embodied by a remote server, such as a road segment indicia server.

At block 701 of FIG. 7, the apparatus 30 embodied by a computing device, such as the road segment indicia server includes means, such as the processing circuitry 32, memory 34, or the like, for maintaining a driving profile database. In some embodiments, the driving profile database may be a master driving profile database. In some embodiments, the road segment indicia server may be configured to generate the driving profile indicia database by populating the master driving profile database with one or more driving profiles. The road segment indicia server may generate one or more driving profile attributes for each driving profile, where the driving attributes may describe lane attributes (e.g., a lane number, left lane or right lane, merging lane, and/or the like), speed attributes (e.g., a recommended speed), deceleration attributes (e.g., a deceleration profile), acceleration attributes (e.g., an acceleration profile), and/or safety attributes (e.g., safety information and/or event information), and/or the like. The road segment indicia server may generate the driving profile attributes based at least in part on one or more driving profiles, such as the driving profile generated using the method described in FIG. 5. Each driving profile may be associated with one or more road segment indicia, such as by mapping the driving profile to the particular road segment indicium within the road segment indicia map database

In some embodiments, the road segment indicia server may generate various driving profiles for various vehicles, classes of vehicles, and/or the like. For example, in some embodiments, each driving profile may correspond to a particular vehicle. The driving profile may be associated with a unique identifier for each vehicle and may further include driving profile metadata such as a vehicle make, model, year, body style, trim level, and/or the like. In some embodiments, a driving profile may correspond to a particular class of vehicles. For example, a driving profile may correspond to four-wheel drive trucks, such as by averaging one or more vehicle driving profiles associated with four-wheel drive trucks to generate the four-wheel drive truck driving profile. Another driving profile may correspond to a particular vehicle model, such as by averaging one or more vehicle driving profiles associated with the vehicle model to generate the vehicle model driving profile. In some embodiments, a single driving profile may correspond to a particular location. For example, the single driving profile may be determined based at least in part on one or more vehicle driving profiles, such as by averaging the one or more vehicle driving profiles to generate the single driving profile.

At block 702 of FIG. 7, the apparatus 30 embodied by a computing device, such as the road segment indicia server includes means, such as the processing circuitry 32, memory 34, communication interface 36 or the like, for providing at least a portion of the driving profile database to one or more vehicles. In some embodiments, the road segment indicia server may receive one or more requests from one or more vehicles for at least a portion of a driving profile database. The request for at least a portion of the driving profile database may be based at least in part on the origin location for the vehicle, destination location for the vehicle, one or more particular routes that may be traversed between the origin location and destination location, and/or the like. The road segment indicia server may then provide the requested portion of the driving profile database to the one or more requesting vehicles, such that the vehicles may access the portion of the driving profile database even when not in communication with the road segment indicia server. In some embodiments, when the road segment indicia server receives a request for a portion of the road segment indicia map database, the road segment indicia server may automatically determine one or more corresponding portions of the driving profile database to provide to the one or more vehicles.

At block 703 of FIG. 7, the apparatus 30 embodied by a computing device, such as the road segment indicia server includes means, such as the processing circuitry 32, memory 34, communication interface 36 or the like, for receiving one or more driving profiles from one or more vehicles. The road segment indicia server may receive one or more driving profiles from one or more vehicles in response to a vehicle trip, which may cause the generation of a driving profile as described with respect to FIG. 5.

At block 704 of FIG. 7, the apparatus 30 embodied by a computing device, such as the road segment indicia server includes means, such as the processing circuitry 32, memory 34, or the like, for updating one or more driving profiles. The road segment indicia server may then update the one or more driving profiles based at least in part on the one or more received driving profiles. For example, the road segment indicia server may be configured to update one or more driving profile attributes based at least in part on the one or more received driving profiles. The road segment indicia server may update the one or more driving profiles in any suitable way. For example, the road segment indicia server may average one or more driving profile attributes, such as a recommended speed, and update the driving profile attribute accordingly. As such, the road segment indicia server may use the driving profile to update one or more driving profiles stored within a master driving profile database. In this way, the one or more driving profiles may be accurately maintained and updated in real-time and/or near real-time.

As such, the methods, apparatuses and computer program products provided in accordance with example embodiments described above are capable of estimating the location of a vehicle based at least in part upon one or more road segment indicia that are described by one or more data objects obtained by one or more sensors onboard the vehicle. By relying at least in part upon the one or more road segment indicia, the location of the vehicle may be estimated with enhanced accuracy in at least some situations, such as in instances in which a GNSS receiver is unable to maintain a line-of-sight with the satellites of a satellite positioning system or otherwise in instances in which the location estimated based upon reliance on satellite or radio signals is considered insufficient. By estimating the location of the vehicle with enhanced accuracy in at least some situations, the vehicle may be navigated in a more informed and reliable manner and the relationship of the vehicle to other vehicles traveling along the same or proximate road segments may be determined with greater confidence. Furthermore, in some embodiments, one or more driving profiles associated with the estimated location of the vehicle may be accessed from a driving profile database and one or more navigational instructions may be generated based at least in part on the one or more driving profiles. As such, the vehicle may be operated in a more reliable manner as compared to conventional methods.

FIGS. 3-7 illustrate flowcharts depicting a method according to an example embodiment of the present invention. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 34 of an apparatus 30 employing an embodiment of the present invention and executed by the processing circuitry 32. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Furthermore, in some embodiments, additional optional operations may be included. Modifications, additions, or amplifications to the operations above may be performed in any order and in any combination.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for estimating the location of a vehicle based at least in part upon one or more road segment attributes for a road segment upon which a vehicle is traveling, the method comprising:
identifying one or more road segment indicia based at least in part upon one or more data objects obtained by one or more sensors onboard the vehicle;
determining one or more road segment attributes for the road segment upon which the vehicle is traveling based at least in part on the one or more identified road segment indicia and using a road segment indicia map database; and
estimating the location of the vehicle based at least in part upon the one or more road segment attributes.

2. The method of claim 1, wherein the one or more road segment attributes include location information for the one or more road segment indicia.

3. The method of claim 1, the method further comprising:
accessing one or more driving profiles associated with the estimated location of the vehicle; and
determining one or more navigational instructions based at least in part on the one or more driving profile attributes for one or more driving profiles.

4. The method of claim 1, wherein:
the one or more road segment indicia include one or more barcodes,
each barcode is assigned a unique barcode identifier, and
determining one or more road segment attributes for the road segment upon which the vehicle is traveling based at least in part on the one or more identified road segment indicia and using a road segment indicia map database comprises:
determining the unique barcode identifier for each road segment indicia; and
matching the unique barcode identifier to a corresponding stored barcode identifier within the road segment indicia map database.

5. The method of claim 1, the method further comprising:
generating a driving profile associated with a vehicle route, wherein (i) the driving profile comprises one or more driving profile attributes, (ii) each of the one or more driving profile attributes is associated with one or more road segment indicia, and (iii) the one or more driving profile attributes includes at least one of a speed profile, deceleration profile, acceleration profile, steering profile, or safety events; and
causing the driving profile to be provided to a road segment indicia server.

6. The method of claim 1, the method further comprising:
identifying a distance between the vehicle and the one or more road segment indicia, wherein estimating the location of the vehicle comprises refining the location of the vehicle within the lane of the road segment based at least in part on the respective distances between the vehicle and the one or more road segment indicia.

7. The method of claim 1, the method further comprising:
detecting a road segment indicum is missing based at least in part upon the one or more data objects and the road segment indicia map database defining respective locations of a plurality of road segment indicia.

8. The method of claim 1, wherein the one or more sensors onboard the vehicle include one or more infrared sensors.

9. A method for providing a road segment indicia map database to one or more vehicles, the method comprising:
maintaining a road segment indicia map database, wherein the road segment indicia map database is configured to store one or more road segment indicia identifiers and one or more corresponding road segment attributes for each road segment indicia identifier; and
providing at least a portion of the road segment indicia map database to one or more vehicles.

10. The method of claim 9, the method further comprising:
maintaining a driving profile database, wherein (i) the driving profile database is configured to store one or more driving profiles, (ii) each driving profile comprises one or more profile attributes, (iii) each of the one or more driving profile attributes is associated with one or more road segment indicia, and (iv) the one or more driving profile attributes includes at least one of a speed profile, deceleration profile, acceleration profile, or steering profile; and
providing at least a portion of the driving profile database to one or more vehicles.

11. The method of claim 10, the method further comprising updating one or more driving profiles in the driving profile database in response to receiving the one or more driving profiles from the one or more vehicles.

12. The method of claim 9, wherein the one or more road segment attributes include at least one or more of location information, lane attributes, speed attributes, deceleration attributes, acceleration attributes, or safety attributes.

13. The method of claim 9, wherein the one or more road segment indicia identifiers each corresponds to a unique barcode identifier.

14. An apparatus comprising:
processor circuitry; and
at least one memory including computer program code,
the at least one memory and the computer program code configured to, with the processing circuitry, cause the apparatus at least to:
identify one or more road segment indicia based at least in part upon one or more data objects obtained by one or more sensors onboard the vehicle;
determine one or more road segment attributes for the road segment upon which the vehicle is traveling based at least in part on the one or more identified road segment indicia and using a road segment indicia map database; and
estimate the location of the vehicle based at least in part upon the one or more road segment attributes.

15. The apparatus of claim 14, wherein the one or more road segment attributes include location information for the one or more road segment indicia.

16. The apparatus of claim 14, the at least one memory and the computer program code are further configured to, with the processing circuitry, cause the apparatus at least to:
access one or more driving profiles associated with the estimated location of the vehicle; and
determine one or more navigational instructions based at least in part on the one or more driving profile attributes for one or more driving profiles.

17. The apparatus of claim 14, wherein:
the one or more road segment indicia include one or more barcodes,
each barcode is assigned a unique barcode identifier, and
the at least one memory and the computer program code are further configured to, when determining one or more road segment attributes for the road segment upon which the vehicle is traveling, with the processing circuitry, cause the apparatus at least to:
determine the unique barcode identifier for each road segment indicia; and
match the unique barcode identifier to a corresponding stored barcode identifier within the road segment indicia map database.

18. The apparatus of claim 14, wherein the at least one memory and the computer program code are further configured to, with the processing circuitry, cause the apparatus at least to:
generate a driving profile associated with a vehicle route, wherein (i) the driving profile comprises one or more driving profile attributes, (ii) each of the one or more driving profile attributes is associated with one or more road segment indicia, and (iii) the one or more driving profile attributes includes at least one of a speed profile, deceleration profile, acceleration profile, steering profile, or safety events; and
cause the driving profile to be provided to a road segment indicia server.

19. The apparatus of claim 14, wherein the at least one memory and the computer program code are further configured to, with the processing circuitry, cause the apparatus at least to:
identify a distance between the vehicle and the one or more road segment indicia,
wherein estimating the location of the vehicle comprises refining the location of the vehicle within the lane of the road segment based at least in part on the respective distances between the vehicle and the one or more road segment indicia.

20. The apparatus of claim 14, wherein the at least one memory and the computer program code are further configured to, with the processing circuitry, cause the apparatus at least to:
detect a road segment indicium is missing based at least in part upon the one or more data objects and the road segment indicia map database defining respective locations of a plurality of road segment indicia.
